(19) United States
(12) Patent Application Publication
(10) Pub. No.: US 2011/0155756 A1
(43) Pub. Date: Jun. 30, 2011

(54) MEDICATION DISPENSER

(75) Inventors: Brian, Lee Ballard, Colwall (GB); Peter, John Sprada, London (GB)

(73) Assignee: MERCK SERONO SA, Coinsins (CH)

(21) Appl. No.: 13/062,607

(22) PCT Filed: Oct. 1, 2009
(86) PCT No.: PCT/IB2009/007006

§ 371 Date: Mar. 7, 2011

(30) Foreign Application Priority Data
Nov. 17, 2008 (EP) 08020008.2

(51) Int. Cl. G07F 11/00

(52) U.S. Cl. 221/78

(57) ABSTRACT

A dispenser for the delivery of medication includes:
a support (9, 10) supporting an array of blister(s) (11) each containing a medication dose, the support (9, 10) having an array of through hole(s) (19, 25) below the blister(s) (11) respectively,
an actuating member (13) located above the support (9, 10), the actuating member (13) being movable in translation relative to the support (9, 10), by at least one step, in a determined direction (d) parallel to the support (9, 10), and
elements (29, 57) for converting each of the step(s) of translational motion of the actuating member (13) into a pressure exerted on corresponding one(s) of the blister(s) (11) towards the corresponding through hole(s) (19, 25) to expel the corresponding medication dose(s) through the corresponding through hole(s) (19, 25).

The present invention pertains to a device for dispensing medication, more particularly to a device for releasing medication from blisters.

Solid medications, in the form of tablets, pills, capsules or the like, are often stored in a blister pack or card, which consists of a sheet, generally of plastic material, defining chambers (blisters) and on the back side of which a sealant film such as an aluminium or a paper foil is fixed. A medication dose contained in a blister may be released by pressing on the blister to collapse the latter and puncture the sealant film.

Releasing medication from a blister is a difficult task for persons having reduced manual dexterity, such as disabled persons or persons suffering from arthrosis, because it requires exerting a sufficient collapsing force on the blister while properly holding the blister pack. This is why devices have been proposed to is facilitate the release of medication from blisters. Such devices are described in International patent applications WO 2004/035421, WO 2004/034952 and WO 2004/101392. The devices according to the first two applications comprise a support for supporting a blister pack and a lid pivotably connected to the support. The lid bears an abutment member which collapses a blister to eject a tablet through a hole provided in the support when the lid is pivoted from its open to its closed position. These devices have several drawbacks:
they require sufficient dexterity to rotate the lid while holding the device,
the size of the device is necessarily large when the lid is open,
risks of the user squeezing his/her fingers between the lid and the support when closing the lid are high,
the blisters are directly accessible to the user when the lid is open. A user may thus manipulate the blisters and release tablets therefrom directly with the hands, which may be dangerous in the case where the medication has a high degree of toxicity. Moreover, the blisters and tablets are exposed to manipulation by children.

The device according to WO 2004/101392 comprises buttons corresponding to respective blisters held in the device. Pressing a button collapses the respective blister and ejects a tablet therefrom. Since the number of buttons has to correspond to the number of blisters, the buttons are small and therefore difficult to operate.

One purpose of the present invention is to provide a medication dispenser which makes particularly easy the release of medication from blisters.

To this end there is provided a dispenser for the delivery of medication, comprising:
a support supporting an array of blister(s) each containing a medication dose, said support having an array of through hole(s) below said blister(s) respectively,
an actuating member located above said support, said actuating member being movable in translation relative to said support, by at least one step, in a determined direction parallel to said support, and
means for converting each of said step(s) of translational motion of the actuating member into a pressure exerted on corresponding one(s) of said blister(s) towards the corresponding through hole(s) to expel the corresponding medication dose(s) through said corresponding through hole(s).

In the context of the present invention, the term “array” is to be understood in a broad sense as including one or more blisters/through holes.

Thus, in the present invention, the medication dose(s) are expelled by translational motion(s) of the actuating member in a direction parallel to the support which supports the blister(s). The pivotable lid and the collapsing buttons of the prior art are therefore not needed.

Moreover, the dispenser according to the invention may comprise a case in which the support, the blister(s), the actuating member and the converting means are provided, and all these elements may be arranged so that the blister(s) are not directly accessible to the user, i.e. cannot be touched by the user, in any configuration of use of the dispenser. In a specific aspect of the invention, the blister(s) cannot be removed from the dispenser. This contributes to protect people who should not be in contact with the medication, in particular young children. Furthermore, risks of contaminating the blister(s) during storage and manipulation of the dispenser are reduced.

Preferably, the through hole(s) of the support communicate with at least one cavity into which the medication dose(s) fall after being expelled from the blister(s), and said cavity(ies) communicate with the inside of a removable cap provided at an end of the dispenser. The medication dose(s) expelled from the blister(s) are collected in the removable cap. The user may thus remove the cap with the medication dose(s) in it and bring the medication dose(s) into his/her mouth without touching them with the hands. In this manner, contamination of the medication by the user's fingers is avoided, as is contamination of the user's skin by the medication.

Since the dispenser according to the invention does not require the use of a pivotable lid, risks of squeezing the user's fingers upon handling the dispenser are reduced.

Typically, the array of blister(s) includes several rows of blisters extending side-by-side in said determined direction, and the medication doses expelled during each of said step(s) of translational motion of the actuating member include at least one medication dose of each of the rows of blisters. In this manner, the dispenser may deliver the correct, posological number of medication doses at each action by the user on the dispenser. This correct, posological number of medication doses typically is 1, 2, 3, 4 or 5.

The medication doses of the different rows of blisters may be expelled simultaneously at each of said step(s) of translational motion of the actuating member. Alternatively, the converting means and the array of blisters may be arranged so that during each of said step(s) of translational motion of the actuating member, respective medication doses of the rows of blisters are expelled successively.

The blisters may be arranged as one blister pack or several separate blister packs.

Preferably, the converting means comprise at least one inclined pressing surface of said actuating member.

Alternatively or additionally, the converting means may comprise an array of inclined pressing member(s), each pressing member being hinged relative to the support at one end and being arranged to be urged by the actuating member to pivot towards corresponding one(s) of said through hole(s) during a corresponding one of said step(s) of translational motion of the actuating member, a free end of said pressing member being arranged to press on corresponding one(s) of said blister(s) to expel the corresponding medication dose(s) therefrom during the pivotal motion of the pressing member. Preferably, the pressing member(s) are hinged at said one end to an upper plate placed on said support and having an array of though hole(s) which receive said blister(s).

Advantageously, the support comprises a rigid base support member and a compressible plate which is supported by the rigid base support member and which supports the blister(s). The through hole(s) of said support each comprise a cutting member. The actuating member comprises at least one pressing member. The dispenser further comprises an array of cam surface(s) stationary relative to the support. The pressing member(s) of the actuating member are arranged to cooperate during each of said step(s) of translational motion of the actuating member with corresponding one(s) of said cam surface(s) before said pressure is exerted so as to move the corresponding blister(s) closer to the rigid base support member by compressing the compressible plate so that a sealant film of the corresponding blister(s) is pre-cut by the corresponding cutting member(s). The pre-cutting of the sealant film facilitates the expelling of the medication doses and avoids too much pressure being applied on the medication doses and causing damage to the latter upon expelling. This is particularly beneficial for medication doses in the form of sectile pills or fragile capsules.

Preferably, the compressible plate is between the rigid base support member and the upper plate, and the upper plate consists of several rigid plate elements connected to one another by flexible links, each rigid plate element having at least one of said inclined pressing members and at least one of said through holes of the upper plate. Typically, each rigid plate element corresponds to one of said steps of translational motion of the actuating member.

Preferably, the dispenser according to the invention further comprises a driving member for driving the actuating member. The driving member is operable by a user and is movable in translation relative to the support in the direction opposite to said determined direction from a first position to a second position and in said determined direction from the second position to the first position. The motion of the driving member from the first position to the second position leaves the actuating member stationary relative to the support and the motion of the driving member from the second position to the first position causes the actuating member to be moved by one of said step(s).

The driving member may comprise opposite guiding members extending parallel to said determined direction and each having indexing elements on its inner face. The actuating member may be located between the guiding members and may have lateral indexing elements cooperating with the indexing elements of the guiding members to define rest positions of the actuating member between said steps of translational motion. The indexing elements of the guiding members may consist of notches and the indexing elements of the actuating member may consist of elastically deformable tabs. The dispenser may further comprise abutment surfaces stationary relative to the support, for holding the actuating member in said rest positions when the driving member is being moved from its first position to its second position.

The medication dispenser according to the invention is particularly adapted to users having dexterity deficiencies, for instance deficiencies caused by diseases like arthritis. In this respect, the medication dispenser also has a suitable weight, typically less than 200 g, preferably less than 150 g, more preferably less than 100 g. The dispenser may be made of metal or synthetic material. The metal may be aluminium or steel. The synthetic material is selected among plastics, thermoplastics and organic polymers. Such organic polymers are preferably PMMA, PVC, polystyrene, polycarbonates, polyethylene or polypropylene. In another aspect, the dispenser may have a length between 119 and 222 mm, a width between 52 and 98 mm and a thickness between 10 and 21 mm.

Another purpose of the present invention is to provide a medication dispenser that is child-resistant. To this end, the case of the dispenser has side walls and top and bottom walls, and the dispenser further comprises:
first locking means coupled to the case,
second locking means coupled to the driving member and engaging said first locking means for locking the driving member in its first position relative to the support,
first and second buttons respectively provided at the side walls, said first and second buttons being operable to disengage said first and second locking means for permitting the driving member to be moved relative to the support in the direction opposite to said determined direction from its first position to its second position,
third locking means for maintaining engagement between the first and second locking means, and
a third button operable to act on the third locking means to permit disengaging the first and second locking means by operating the first and second buttons.

Typically, the first and second buttons are operable to act on the first locking means to disengage the first and second locking means.

The third locking means may be arranged to block the first locking means when an attempt is made to operate the first and second buttons while the third button is in a rest position.

In a particular embodiment, the first and second buttons are push buttons and the third button is a slide button.

The third locking means may be sides of a slidable part which carries the third button, said sides being arranged to block stop projections of the first locking means when an attempt is made to operate the first and second buttons while the third button is in a rest position, said sides comprising holes into which the stop projections enter when the third button is in an operated position and the first and second buttons are pressed.

Advantageously, the sides of the slidable part further comprise stop projections which are blocked by the stop projections of the first locking means when the first and second buttons are pressed, to prevent the third button from moving from its rest position to its operated position.

The third button may be provided at the top wall of the case.

Advantageously, the first and second buttons are arranged to disengage the first and second locking means only when operated simultaneously.

The dispenser according to the invention is particularly suitable for containing drug for the treatment of cancer, drug having an immediate toxic effect or drug having an effect on the immune system.

According to a particular embodiment, the medication comprises Cladribine or derivatives thereof.

The present invention further provides a kit comprising a dispenser as defined above and a description containing information on how to handle the dispenser and on the administration and dosing of the medication.

The present invention further provides a method of operating a dispenser as defined above, comprising the following steps:
pulling the driving member from its first position to its second position relative to the support,
pushing the driving member from its second position to its first position relative to the support,
inclining the dispenser to make the expelled medication dose(s) fall into the cap by gravity, and
removing the cap to recover the expelled medication dose(s).

The present invention further provides a method of operating a dispenser as defined above, comprising the following steps:
holding the case in a first hand,
operating the third button with a finger of the second hand,
operating the first and second buttons with two fingers of the first hand while maintaining the third button in its operated position,
pulling the driving member relative to the support with the second hand while maintaining the first and second buttons in their operated position to unlock the driving member,
continuing to pull the driving member until it reaches its second position relative to the support,
pushing the driving member from its second position to its first position relative to the support,
inclining the dispenser to make the expelled medication dose(s) fall into the cap by gravity, and
removing the cap to recover the expelled medication dose(s).

Other features and advantages of the present invention will be apparent upon reading the following detailed description made with reference to the appended drawings in which:

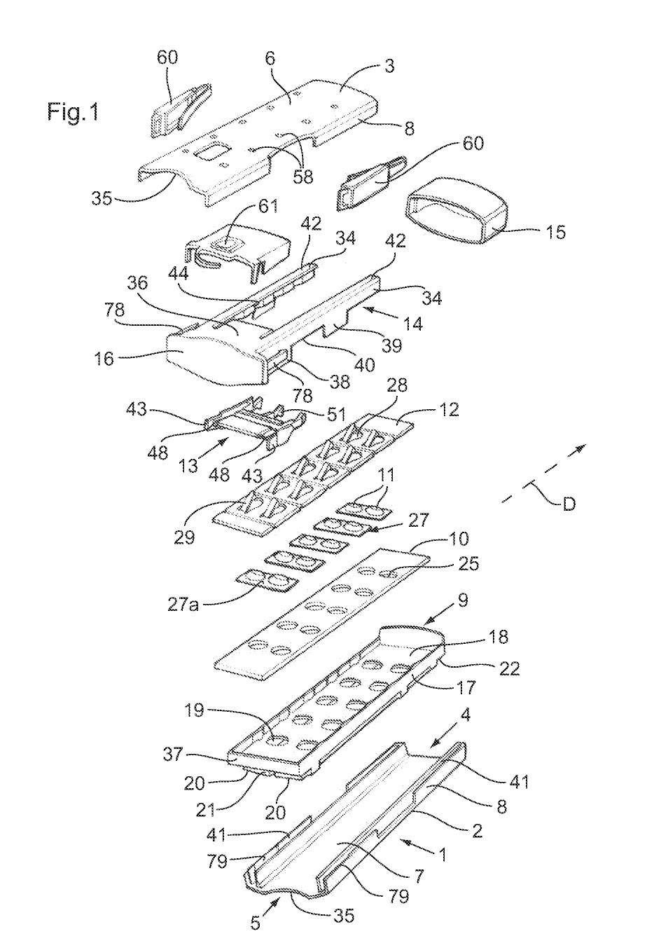

FIG. 1 is an exploded perspective view from above of a medication dispenser according to the invention;

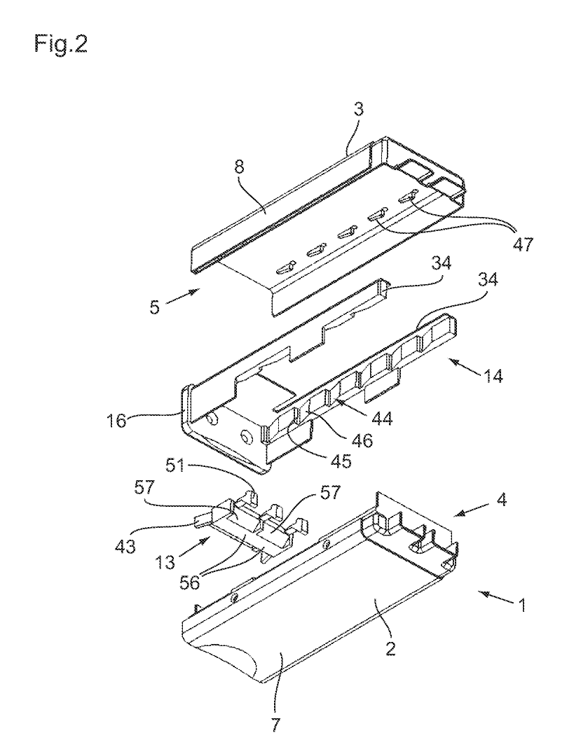

FIG. 2 is an exploded perspective view from below of the medication dispenser according to the invention;

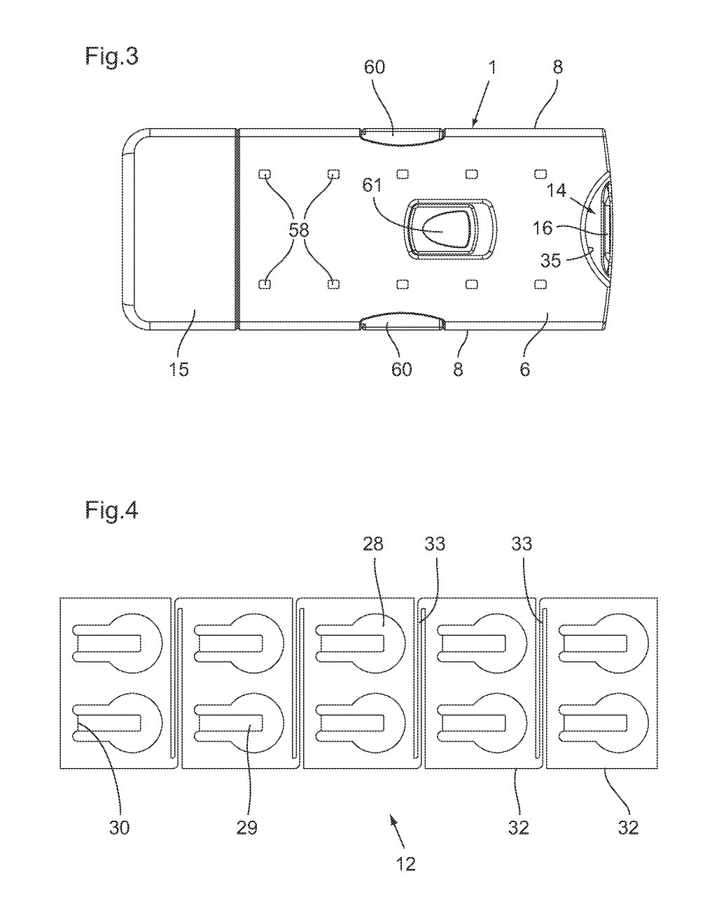

FIG. 3 is a top plane view of the medication dispenser according to the invention;

FIG. 4 is a top plane view of a plate used in the medication dispenser according to the invention;

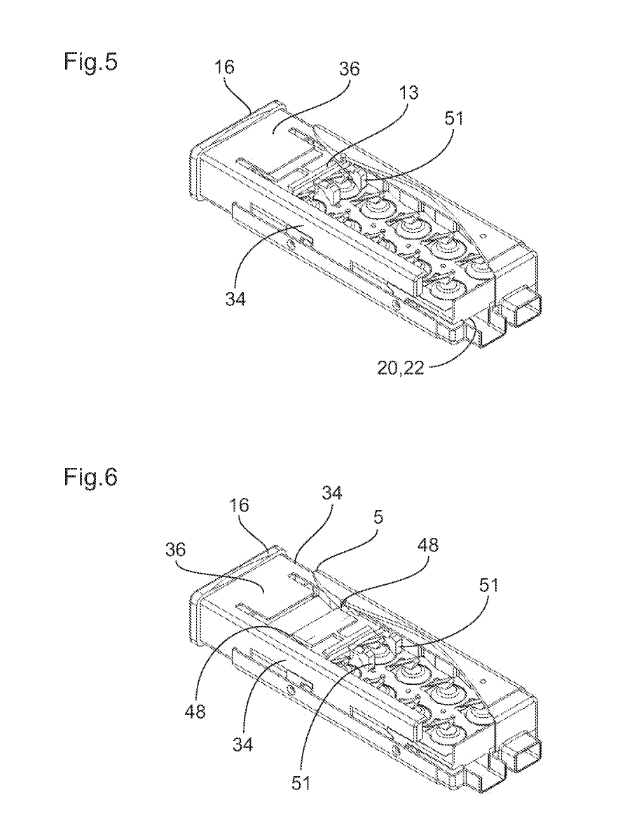

FIG. 5 is a cutaway perspective top view of the medication dispenser according to the invention showing a driving member in a rest position and an actuating member in a given position;

FIG. 6 is a cutaway perspective top view of the medication dispenser according to the invention showing the driving member in a pulled position and the actuating member in the given position;

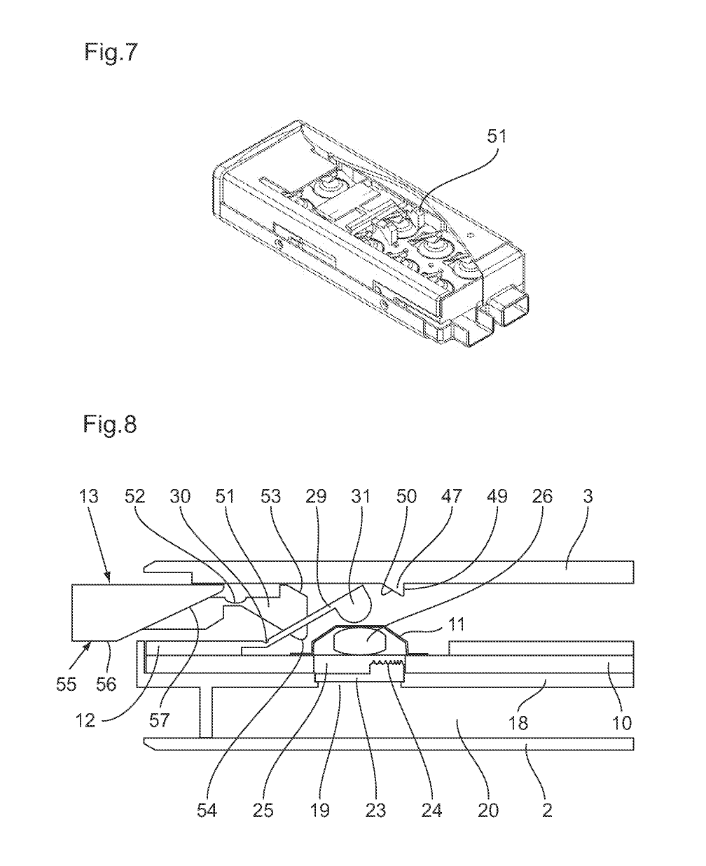

FIG. 7 is a cutaway perspective top view of the medication dispenser according to the invention showing the driving member in its rest position and the actuating member in a next position;

FIGS. 8 to 12 are schematic partial sectional views of the medication dispenser according to the invention showing how a tablet is expelled from a blister;

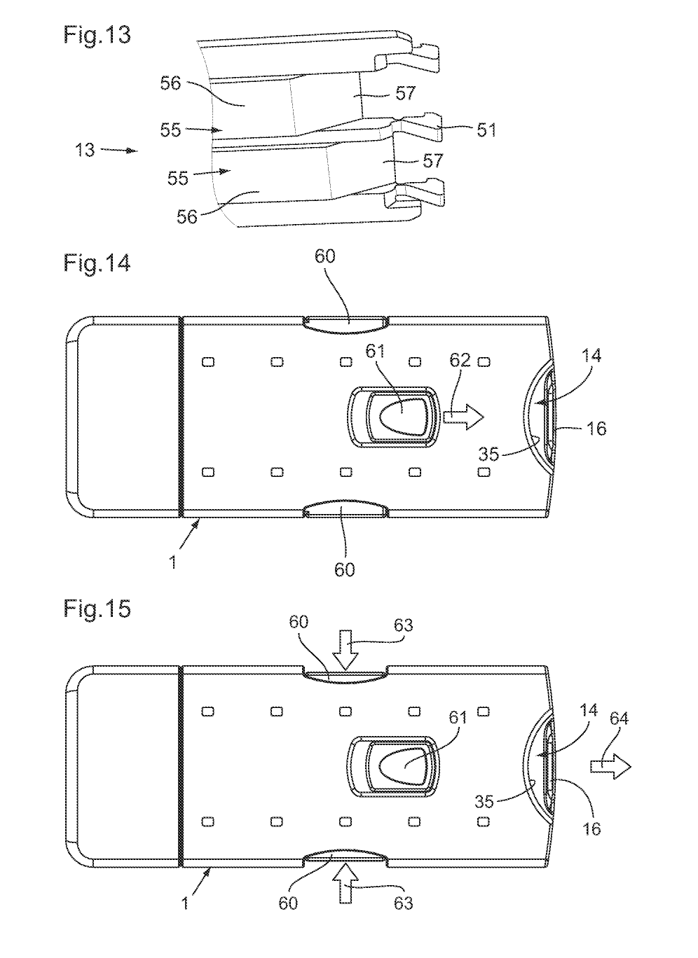

FIG. 13 is a bottom plane view of the actuating member according to an alternative embodiment;

FIGS. 14 and 15 show in top plane view a sequence of actions required to unlock the driving member;

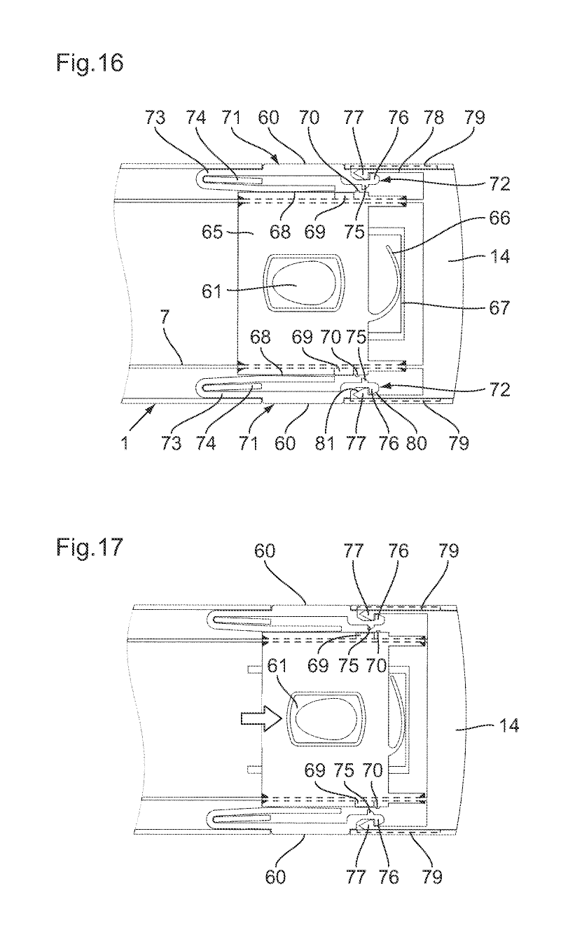

FIG. 16 is a schematic top plane view of the internal mechanism of the medication dispenser according to the invention for locking/unlocking the driving member;

FIGS. 17 to 19 schematically show in top plane view the successive configurations of the internal mechanism of FIG. 16 during the said sequence of actions.

In the following, the terms “upper”, “lower”, “upward”, “downward”, “horizontal”, “vertical”, “front”, “rear”, “forward”, “rearward” will be used with reference to the position of the dispenser as shown in FIG. 1.

Referring to FIGS. 1 to 3, a medication dispenser according to a preferred embodiment of the invention comprises a case 1 formed of a bottom part 2 and of a top part 3 assembled together. The case 1 extends in a longitudinal direction D and has two open ends, referred to as front end 4 and rear end 5, a top wall 6, a bottom wall 7 and two longitudinal side walls 8. Inside the case 1 are provided a rigid chassis 9, a foam plate 10, an array of blisters 11, an upper plate 12, a movable actuating member 13 and a movable driving member 14 for driving the actuating member 13. A removable end cap 15 closes the front end 4 of the case 1. An enlarged end portion 16 of the driving member 14 closes the rear end 5 of the case 1.

The chassis 9 is fixed to the case 1 and has a frame 17 in which a base support plate 18 having an array of through holes 19 is fixed. Typically, the array of through holes 19 defines side-by-side longitudinal rows of through holes 19, i.e. rows that extend side-by-side in the longitudinal direction D, and side-by-side lateral rows of through holes 19, i.e. rows that extend side-by-side in a direction orthogonal to the longitudinal direction D. In the example shown, two longitudinal rows of five through holes 19, or in other words five lateral rows of two through holes 19, are provided. The base support plate 18 may be a separate part assembled to the frame 17 or may be integrally formed with the frame 17. The lower face of the chassis 9 defines longitudinal separate recesses 20 (see FIGS. 1 and 5) respectively located below the longitudinal rows of through holes 19 in order to communicate each with the through holes 19 of the respective row. The rear end 21 of each recess 20 is closed. The front end 22 of each recess 20 is open so as to communicate with the inside of the end cap 15. The recesses 20 and the bottom wall 7 form together longitudinal cavities which communicate with the inside of the end cap 15. A ring 23 (visible in FIG. 8), typically of metal, is fixed to the internal face of each through hole 19 of the base support plate 18, coaxially with the through hole 19. Each ring 23 has a cutting edge 24 extending as an arc of a circle and projecting upwards from the upper face of the base support plate 18. The cutting edge 24 may have teeth, as shown.

The foam plate 10 rests on the upper face of the base support plate 18. The foam plate 10 may be fixed to the base support plate 18, for example by gluing. The foam plate 10 has an array of through holes 25 respectively aligned vertically with the through holes 19 of the base support plate 18. Each through hole 25 of the foam plate 10 receives the projecting cutting edge 24 of the respective ring 23.

The blisters 11 each include a medication dose 26 in the form of a tablet, a pill, a capsule or the like. The blisters 11 are disposed on the upper face of the foam plate 10 so as to be vertically aligned with the through holes 25, 19 of the foam plate 10 and the base support plate 18. In the example shown, the blisters 11 are arranged as several separate blister packs 27 each forming one lateral row of blisters. Providing the blisters in small separate blister packs, as is shown, facilitates the management of the quantities of medication and permits reducing medication wastage. In a variant, however, a single larger blister pack could be provided on the foam plate 10 to form the array of blisters.

The upper plate 12 is placed above the foam plate 10 and the flat part, referenced 27a, of the blister packs 27, and is retained in the frame 17 of the chassis 9 for example by elastically deformable members projecting from the inner face of the frame 17. The upper plate 12 has an array of through holes 28 vertically aligned with the through holes 19, 25 of the support and foam plates 18, 10 and in which the blisters 11 are received. The upper plate 12 carries pressing members 29 that take the form of tabs projecting obliquely upward and forward from the upper plate 12 and that are hinged at one end to the upper plate 12. As shown in FIGS. 4 and 8, the pressing members 29 may be integrally formed with the upper plate 12 and the hinges, referenced 30, may be elastic hinges formed by thin portions of the upper plate 12. The pressing members 29 are associated with the through holes 28 and the blisters 11. The free end of each pressing member 29 comprises an abutment member 31 of greater thickness than the rest of the pressing member 29 and which rests against the top of the respective blister 11 due to the elastic force exerted by the hinge 30.

The upper plate 12 is more precisely formed of several rigid plate elements 32 connected to one another through flexible attachment members 33, as shown in FIG. 4. Each plate element 32 comprises one lateral row of the through holes 28 and the respective pressing members 29. The plate elements 32 are thus movable relative to one another. In particular, each plate element 32 may be moved downward, causing the foam plate 10 to be compressed, independently of the other plate elements 32.

Referring back to FIGS. 1 and 2, the driving member 14 has two lateral longitudinal guiding members 34 which project from the enlarged end portion 16 and maintain the driving member 14 in the case 1 while allowing it to move longitudinally forward (i.e. in the direction D) and backward (i.e. in the direction opposite to the direction D) relative to the case 1 between a rest position (shown in FIG. 5) where the enlarged end portion 16 closes the rear end 5 of the case 1 and a pulled position (shown in FIG. 6) where the enlarged end portion 16 is distant backward from the read end 5. In the rest position of the driving member 14, part of the upper face and of the lower face of the enlarged end portion 16 is exposed through recesses 35 formed in the rear end 5 to enable the' user to seize the enlarged end portion 16. In both the rest and pulled positions of the driving member 14, the blisters 11 remain inaccessible to the user. To this effect, the driving member 14 has an upper wall 36 between the guiding members 34 and next to the enlarged end portion 16. This upper wall 36 prevents access to the inside of the case 1 from the upper side of the driving member 14. Access from the lower side of the driving member 14 is prevented by a similar lower wall of the driving member 14 and/or by an end rear wall 37 of the chassis 9. The guiding members 34 each comprise first and second wall extensions 38, 39 oriented downward and separated by a recess 40. The extensions 38, 39 of each guiding member 34 are guided in a respective lateral longitudinal groove 41 formed in or at a lateral wall of the case bottom part 2. A stop member (not shown), such as a screw, a pin or the like, is fixed laterally in each of the lateral walls of the case bottom part 2 so as to be located in the recess 40 between the wall extensions 38, 39 and thus in the path of the guiding member 34. These stop members limit the motions of the driving member 14, by being abutted by the second wall extensions 39 to prevent the driving member 14 from being pulled beyond the said pulled position, and by being abutted by the first wall extensions 38 to prevent the driving member 14 from being pushed beyond the rest position. In the rest position of the driving member 14, alternatively to the abutment of the first wall extensions 38 against the stop members, the enlarged end portion 16 of the driving member 14 may abut against the rear end 5 of the case 1 or against the end wall 37 of the chassis 9.

The actuating member 13 is disposed on the upper plate 12 and retained vertically by upper walls 42 of the guiding members 34. The actuating member 13 comprises lateral tabs 43 in its rear portion which cooperate with notches 44 provided in the inner faces of the guiding members 34. Each notch 44 (see FIG. 2) is defined by a laterally-oriented surface 45 and an inclined surface 46 forming an angle together, with the inclined surface 46 being located forward to the laterally-oriented surface 45. The notches 44 and tabs 43 form indexing means defining determined successive rest longitudinal positions for the actuating member 13. The actuating member 13 is held in each of said rest positions by the free ends of the tabs 43 being each blocked substantially at the edge of intersection between the two surfaces 45, 46 of one notch 44. The notches 44 and the tabs 43 also form a detent mechanism that moves the actuating member 13 longitudinally forward by one step, i.e. from one rest position to the next, when the driving member 14 is pushed from its pulled position to its rest position and that enables the driving member 14 to be pulled from its rest position to its pulled position without moving the actuating member 13. The laterally-oriented surfaces 45 of two opposite notches 44 of the respective guiding members 34 indeed form abutment surfaces which push the actuating member 13, more precisely the free end of the tabs 43, when the driving member 14 is pushed from its pulled to its rest position. The inclined surfaces 46 of two opposite notches 44 of the respective guiding members 34 form sliding surfaces which slide on the free end of the elastic tabs 43 while elastically deforming the tabs 43 inward when the driving member 14 is pulled from its rest position to its pulled position. To hold the actuating member 13 in place relative to the upper plate 12, chassis 9 and case 1 when the driving member 14 is being pulled, projections 47 are provided on the inner upper face of the case top part 3, which cooperate with tabs 48 (see FIG. 6) provided at the rear of the actuating member 13. The projections 47 have a vertical abutment surface 49 (see FIG. 8) for cooperating with the tabs 48 to block the actuating member 13 in the backward direction, and an inclined cam surface 50 which allows the actuating member 13 to move forward by causing an elastic downward deformation of the tabs 48. The stroke of the driving member 14 between the rest and pulled positions is equal to the distance between two adjacent notches 44 and to the distance between two adjacent through holes 28 (two adjacent blisters 11) in the longitudinal direction D.

The actuating member 13 further comprises pressing members 51 (best visible in FIGS. 5-7 and 8-12) which project longitudinally forward from the body of the actuating member 13 and which are laterally offset relative to the pressing members 29 and the through holes 28 of the upper plate 12 so as not to interfere with the pressing members 29 and the through holes 28 during motion of the actuating member 13. In the example shown, three pressing members 51 are provided, respectively between one lateral longitudinal side of the upper plate 12 and one longitudinal row of through holes 28, between the two longitudinal rows of through holes 28, and between the other longitudinal row of through holes 28 and the other lateral longitudinal side of the upper plate 12. The pressing members 51 are hinged to the body of the actuating member 13. As shown in FIG. 8, the pressing members 51 may be integrally formed with the body of the actuating member 13 and elastically hinged to it through a thinner portion 52. The free end of each pressing member 51 is thicker than the base portion next to the hinge 52, and has an inclined surface 53 in its upper portion and a lower rounded surface 54 in contact with the upper plate 12.

Besides the function of retaining the actuating member 13 when the driving member 14 is being pulled, the projections 47 have a function of actuating the pressing members 51, as will be explained later. The projections 47 are arranged in longitudinal rows which are laterally aligned to one another and longitudinally aligned, respectively, with the pressing members 51. In the example shown, two lateral longitudinal rows of projections 47 are used for both functions and one central longitudinal row of projections 47 is used for the second function only. Each lateral row of the projections 47 is associated with one lateral row of blisters 11.

The actuating member 13 further comprises pressing surfaces 55 which are aligned, respectively, with the longitudinal rows of the pressing members 29. Each pressing surface 55 comprises a horizontal rearward surface portion 56 which rests and slides on the upper plate 12 and a forward surface portion 57 that is inclined forward and upward from the rearward surface portion 56.

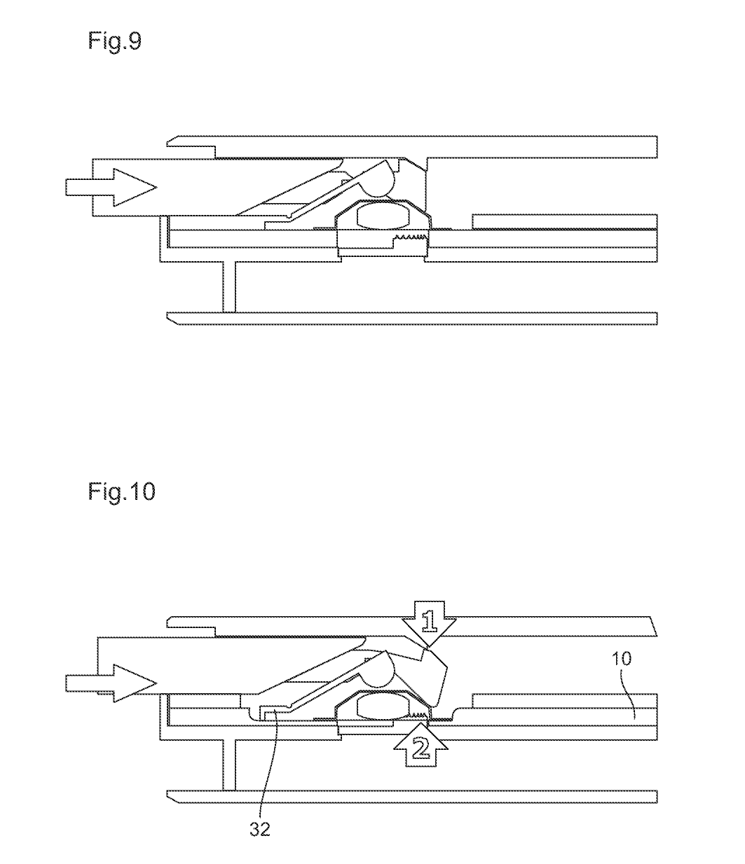

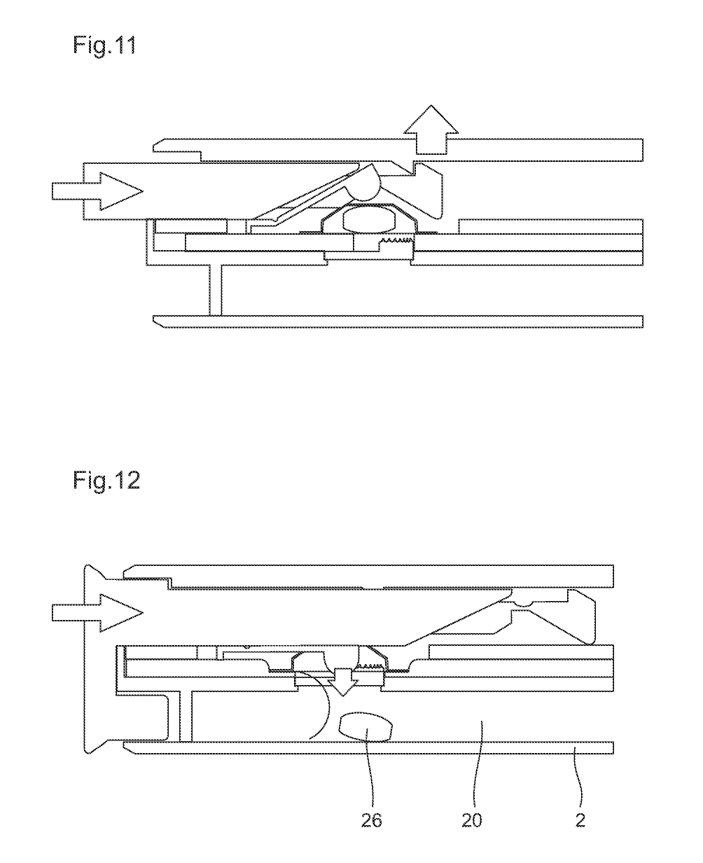

The dispenser according to the invention operates as follows. To release medication doses 26 from a lateral row of blisters 11, the user pulls the driving member 14 relative to the case 1 from its rest position to its pulled position (FIG. 6). The actuating member 13 does not move during this rearward motion of the driving member 14, since it is retained by the abutment surfaces 49 of the projections 47. The tabs 43 however are deformed inward by the inclined surfaces 46 of one pair of opposite notches 44 of the guiding members 34, and return into their non-deformed rest condition when the next pair of opposite notches 44 reaches them, which corresponds to the pulled position of the driving member 14. Then, the user pushes the driving member 14 back to its rest position (FIG. 7), which causes the laterally-oriented surfaces 45 of said next pair of opposite notches 44 to cooperate with the tabs 43 of the actuating member 13 to push the actuating member 13 by one step forward. During this one-step forward motion of the actuating member 13, the pressing members 51 come into contact with one lateral row of projections 47, which causes the inclined cam surfaces 50 thereof to cooperate with the inclined surfaces 53 of the pressing members 51 to move the pressing members 51 downward by elastic deformation of the hinges 52 (FIGS. 9, 10), thereby moving the corresponding upper plate element 32 downward by compressing the foam plate 10. The downward motion of the upper plate element 32 brings the sealant film of the corresponding blisters 11 into contact with the cutting edge 24 of the corresponding rings 23. The cutting edge 24 pre-cuts the sealant film in the zone of the corresponding blisters 11. Still in this one-step forward motion of the actuating member 13, after the pressing members 51 have left contact with the inclined surfaces 50, they are returned into their rest, horizontal position by the elastic hinges 52 (FIG. 11). Next, the inclined forward surface portions 57 and then the horizontal rearward surface portions 56 of the actuating member 13 come into contact with the pressing members 29 and urge them down to press and collapse the blisters 11 (FIG. 12). The medication doses 26 are expelled from the blisters 11 through the already punctured sealant film and fall into the cavities defined by the recesses 20 and the case bottom part 2. The one-step forward motion of the actuating member 13 is completed after all these operations, i.e. puncturing the blister film and expelling the medication doses 26 of one lateral row of blisters 11, have been made. By inclining the dispenser, the user makes the medication doses 26 fall by gravity into the cap 15 which communicates with the aforementioned cavities. Next, the user removes the cap 15 with the medication doses 26 in it and can bring the medication doses 26 into his/her mouth without touching them with the hands. The same sequence of operations as above will later be performed to release the medication doses 26 from the next lateral row of blisters 11, and so on.

Thus, expelling the medication doses 26 from one lateral row of blisters 11 merely requires a first, linear pulling action and a second, linear pushing action on the driving member 14. Due to its size, the enlarged end 16 of the driving member 14 may be easily seized. The pulling action may be easily performed with one hand while holding the case 1 with the other hand. The pushing action may be performed similarly, or with one hand only, for example by setting the dispenser orthogonally to a surface, such as a table surface or a wall surface, and by pressing the driving member 14 while the front end of the dispenser (defined by the cap 15) is resting on that surface. A low dexterity is sufficient to perform the sequence of the pulling and pushing actions. Moreover, this sequence remains the same irrespective of the position of the actuating member 13 in the case 1. Thus, the user need not know how many blisters 11 have already been collapsed before operating the dispenser.

In an advantageous variant of the invention, the pressing surfaces 55 of the actuating member 13 are longitudinally offset as shown in FIG. 13 so that during a one-step motion of the actuating member 13 the blisters 11 of the corresponding lateral row of blisters 11 are collapsed successively. This configuration reduces the force required from the user to expel each medication dose 26. In another variant, the pressing surfaces 55 could be laterally aligned and the longitudinal rows of blisters 11 could be longitudinally offset.

The bottom case part 2 may be made transparent to allow the user to see which blisters 11 have already been collapsed and hence how many medication doses are left in the dispenser. In a variant or additionally, as shown in FIGS. 1 and 3, the top case part 3 may have at least one window 58 at each of the determined rest positions of the actuating member 13 and the actuating member 13 or part of it may be of a specific colour, for example red, different from the colour of the top case part 3 so that the position of the actuating member 13 is indicated by the window(s) 58 through which that specific colour is visible. The windows 58 may be in the form of through holes provided in the top wall 6, as shown.

Besides the above-mentioned advantages, the dispenser according to the invention is advantageous in that it always keeps a limited size, in that the risks of squeezing the user's fingers upon manipulation by the user are low, and in that the blisters are inaccessible, which provides a protection for people who should not be in contact with the medication, in particular children, as well as for the patient himself in the case where the medication has a high degree of toxicity and must is not be contacted by the skin. The dispenser according to the invention is most preferably used for anti-cancer drugs, drugs having an immediate toxic effect of drugs having an effect on the immune system, such as purine analogues, in particular Cladribine or derivatives thereof. Cladribine is a chlorinated purine analogue which has been suggested to be useful in the treatment of multiple sclerosis (EP 626 853) and cancer.

Typically, the dispenser according to the invention is for single use. Once all blisters 11 are empty, the dispenser is disposed of. The dispenser, more precisely the bottom and top case parts 2, 3, the chassis 9, the upper plate 12, the actuating member 13, the driving member 14 and the removable end cap 15, may be made of metal or of a synthetic material, such as an organic polymer.

The number of blisters 11 in the dispenser may of course vary. The array of blisters 11 could include one longitudinal row, instead of two as shown, or more than two longitudinal rows depending on the posology for which the dispenser is conceived. The dispenser could even include a single blister. The number of through holes 19, 25, 28 and pressing members 29, 51 would of course be adapted to the number of blisters 11 required. However, one could select a standard size for the dispenser and a standard number of through holes 19, 25, 28 and pressing members 29, 51 and the number of blisters 11 would be either equal to or lower than the number of through holes 19, respectively 25, respectively 28, and pressing members 29 depending on the posology.

In a variant, the upper plate 12 could be entirely rigid, instead of being made of several hinged rigid elements 32, and the foam plate 10 and the cutting rings 23 could be removed. The cutting rings 23 are not necessary but they permit the use of smaller sized pressing members 29 and actuating member 13 by reducing the force required to expel the medication doses 26 from the blisters 11.

Also, the pressing members 29 or the inclined forward surface portions 57 could be removed.

A same pressing member 29, extending laterally, could be used for each is lateral row of blisters 11.

Moreover, the stroke of the driving member 14 could be increased so that a one-step motion of the actuating member 13, caused by one pulling action followed by one pushing action on the driving member 14, causes the medication doses in several lateral rows of blisters to be expelled.

Advantageously, to confer a further protection for people who should not be in contact with the medication, in particular children, the dispenser according to the invention comprises a locking mechanism which locks the driving member 14 in its rest position to prevent the release of medication doses 26. The locking mechanism comprises buttons which must be operated according to a specific sequence to unlock the driving member 14. In the example shown (see FIG. 3), these buttons include opposite push buttons 60 provided in respective openings in the side walls 8 of the case 1 and a slide button 61 provided in an opening in the top wall 6 of the case 1. The term “button” is to be understood here in a broad sense, as covering any part on which a finger can rest to transmit a force. The specific sequence of operations to be performed to unlock the driving member 14 is the following :
operate the slide button 61 as shown by arrow 62 in FIG. 14,
then operate the lateral push buttons 60 as shown by arrows 63 in FIG. 15 while maintaining the slide button 61 in its operated position,
and then pull the driving member 14 as shown by arrow 64 while maintaining the lateral push buttons 60 in their operated position.
   Once the lateral push buttons 60 are operated, the user may release the slide button 61. Maintaining the lateral push buttons 60 in their operated position is required only at the beginning of pulling the driving member 14, to unlock the latter. Then the driving member 14 may be freely moved toward its pulled position without maintaining pressure on the push buttons 60. Typically, the dispenser is held in one hand with the thumb and another finger of the hand acting on the lateral push buttons 60 and a finger of the other hand acting on the top slide button 61, the said other hand being used to pull the driving member 14 after releasing the top slide button 61.

It will thus be appreciated that three actions have to be performed by the user, in a determined order, to unlock the driving member 14. As will be explained below, operating the lateral push buttons 60 while the slide button 61 is not in its operated position is not possible because the slide button 61, in its rest position, blocks the lateral push buttons 60 and prevents them from moving beyond an intermediate pressed position in which the driving member 14 is still locked. Operating the slide button 61 while a pressure is applied on one or two of the lateral push buttons 60 is not possible either, because the lateral push buttons 60, in their intermediate pressed position, block the slide button 61. Merely operating the slide button 61 frees the lateral push buttons 60 but does not free the driving member 14. Simultaneous pressure holding on the operated lateral push buttons 60 and pulling action on the driving member 14 are required to unlock the driving member 14.

A child will generally not have the manual dexterity nor the cognitive knowledge to perform the above-described sequence of operations required to unlock the driving member 14. Moreover, the case 1 may be made sufficiently wide for the lateral buttons 60 to be separated by a large distance, thereby making s it impossible for a child to hold the dispenser in one hand and to press the lateral buttons 60 while holding the slide button 61 in its operated position or to pull the driving member 14 while pressing the lateral buttons 60.

The internal mechanism allowing the above-described sequence of operations is diagrammatically shown in FIGS. 16 to 19. The slide button 61 projects from and is rigidly connected to a plate 65 that is slidably guided in the case 1 above the blisters 11 and the actuating member 13 in a direction parallel to the longitudinal direction D of the dispenser. A return spring 66 is provided between the rear end of the plate 65 and a bearing part 67 rigidly connected to the inner face of the top wall 6 of the case 1. The return spring 66 may be a leaf spring made of one-piece construction with the plate 65 and the button 61, as shown. Alternatively, it could be a conventional metal leaf or helical spring disposed between the rear end of the plate 65 and the bearing part 67. The two sides 68 of the plate 65 along the longitudinal direction D of the dispenser include respective opposite holes 69 and, between the holes 69 and the rear end of the plate 65, respective stop projections 70.

Each lateral push button 60 is part of a piece 71 comprising, inside the case 1, a locking part 72 and a return U-bent leaf spring 73 extending between a corresponding side 68 of the plate 65 and the button 60. The piece 71 is held by a part 74 rigidly connected to the case 1. The locking part 72 comprises a stop projection 75 extending inwardly in the lateral direction and a locking member 76 extending outwardly in the lateral direction. The locking member 76 engages a corresponding locking member 77 of the driving member 14 to lock the driving member 14, as is shown in FIG. 16. The locking member 77 extends inwardly in the lateral direction and is located at the end of an arm 78 of the driving member 14. The stop projection 75 has two functions. A first function is to come into abutment against the corresponding side 68 of the plate 65 when the push button 60 is pressed and the slide button 61 is in its rest position, shown in FIG. 16, to prevent the piece 71 and the push button 60 from going beyond the aforementioned intermediate pressed position in which the locking member 76 still engages the locking member 77, in other words to prevent disengagement of the locking members 76, 77. The second function is to block the stop projection 70 when the slide button 61 is moved toward its operated position while the push button 60 is held in its intermediate pressed position, thereby preventing the slide button 61 from reaching its operated position.

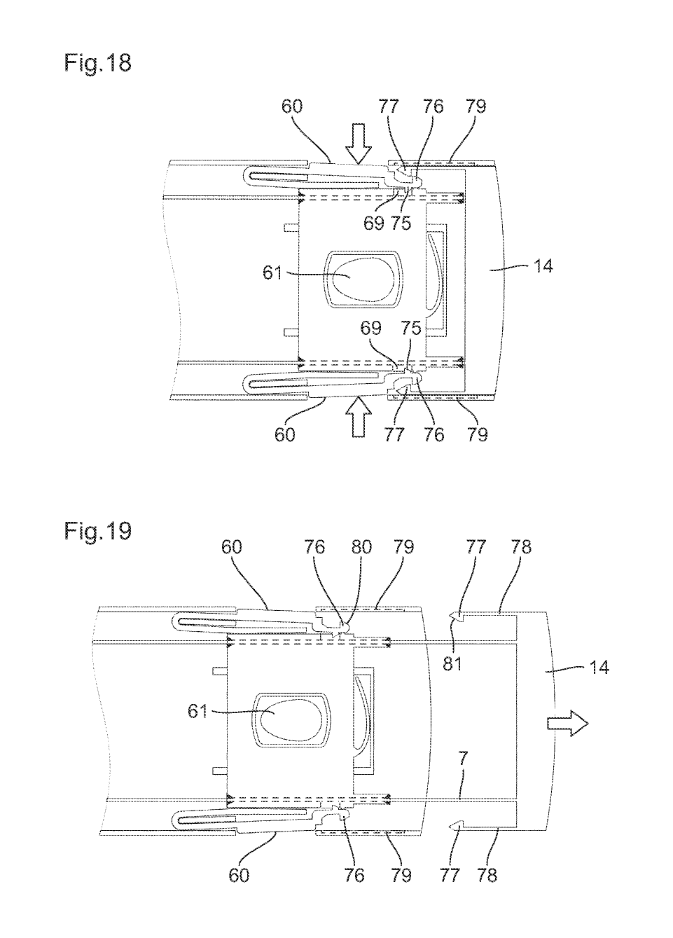

When the push buttons 60 are in their rest position, the stop projections 75 do not interrupt the paths of the stop projections 70 and therefore do not hinder the movement of the slide button 61, which can thus be moved up to its operated position. When the slide button 61 is in its operated position (FIG. 17), the stop projections 75 face the holes 69. In this configuration, if the lateral push buttons 60 are pressed, the stop projections 75 will enter the holes 69, enabling the pieces 71 and push buttons 60 to go beyond the aforementioned intermediate position and to reach their operated position, shown in FIG. 18. In this operated position, the locking members 76 are out of engagement with the locking members 77 and the driving member 14 is therefore free. The driving member 14 may thus be slid out to reach its pulled position (FIG. 19). The sides 68 of the plate 65, with their holes 69 and their surfaces of contact with the stop projections 75, thus constitute locking means serving to prevent the locking members 76 from disengaging with the locking members 77 or to enable such a disengagement.

So long as the lateral push buttons 60 are held in their operated position, the slide button 61 is blocked in its operated position due to the cooperation between the stop projections 75 and the holes 69. Once the buttons 60 have been released by the user, they are returned to their respective rest positions by the springs 73. The driving member 14 may be returned to its locked rest position, to expel medication doses 26 from blisters 11, merely by pushing it forward. Internal faces of the side walls 8 of the case 1 have recesses 79. The locking members 76, 77 have inclined surfaces 80, 81 (see FIG. 16) that cooperate when the driving member 14 is pushed forward while the buttons 60 are in their rest position, causing the arms 78 of the driving member 14 to deform externally into the recesses 79 until the locking members 77 recover their locked position in which they engage the locking members 76.

In a variant of the invention, the lateral push buttons 60 could be of one-piece construction with the case 1 and could be in the form of tabs defined by cut-outs made in the side walls 8 of the case 1 and elastically hinged to the rest of the case 1.

1. Dispenser for the delivery of medication, comprising:
a support supporting an array of blister(s) each containing a medication dose, said support having an array of through hole(s) below said blister(s) respectively,
an actuating member located above said support, said actuating member being movable in translation relative to said support and said array of blister(s), by at least one step, in a determined direction parallel to said support, and
means for converting each of said step(s) of translational motion of the actuating member into a pressure exerted on corresponding one(s) of said blister(s) towards the corresponding through hole(s) to expel the corresponding medication dose(s) through said corresponding through hole(s).

2. Dispenser according to claim 1, wherein said array of blister(s) includes several rows of blisters extending side-by-side in said determined direction, and wherein the medication doses expelled during each of said step(s) of translational motion of the actuating member include at least one medication dose of each of the rows of blisters.

3. Dispenser according to claim 2, wherein the converting means and the array of blisters are arranged so that during each of said step(s) of translational motion of the actuating member respective medication doses of the rows of blisters are expelled successively.

4. Dispenser according to claim 1, wherein the converting means comprise at least one inclined pressing surface of said actuating member.

5. Dispenser according to claim 1, wherein the converting means comprise an array of inclined pressing member(s), each pressing member being hinged relative to the support at one end and being arranged to be urged by the actuating member to pivot towards corresponding one(s) of said through hole(s) during a corresponding one of said step(s) of translational motion of the actuating member, a free end of said pressing member being arranged to press on corresponding one(s) of said blister(s) to expel the corresponding medication dose(s) therefrom during the pivotal motion of the pressing member.

6. Dispenser according to claim 5, wherein the pressing member(s) are hinged at said one end to an upper plate placed on said support and having an array of though hole(s) which receive said blister(s).

7. Dispenser according to claim 6, wherein said support comprises a rigid base support member and a compressible plate which is supported by the rigid base support member and which supports the blister(s), wherein said through hole(s) of said support each comprise a cutting member, wherein the actuating member comprises at least one pressing member, wherein the dispenser further comprises an array of cam surface(s) stationary relative to the support, and wherein the pressing member(s) of the actuating member are arranged to cooperate during each of said step(s) of translational motion of the actuating member with corresponding one(s) of said cam surface(s) before said pressure is exerted so as to move the corresponding blister(s) closer to the rigid base support member by compressing the compressible plate so that a sealant film of the corresponding blister(s) is pre-cut by the corresponding cutting member(s).

8. Dispenser according to claim 7, wherein said compressible plate is between said rigid base support member and said upper plate, and wherein said upper plate consists of several rigid plate elements connected to one another by flexible links, each rigid plate element having at least one of said inclined pressing members and at least one of said through holes of said upper plate.

9. Dispenser according to claim 1, further comprising a driving member for driving said actuating member, said driving member being operable by a user and being movable in translation relative to the support in the direction opposite to said determined direction from a first position to a second position and in said determined direction from the second position to the first position, wherein the motion of the driving member from the first position to the second position leaves the actuating member stationary relative to said support and the motion of the driving member from the second position to the first position causes the actuating member to be moved by one of said step(s).

10. Dispenser according to claim 9, wherein the driving member comprises opposite guiding members extending parallel to said determined direction and each having indexing elements on its inner face, wherein the actuating member is located between said guiding members and has lateral indexing elements cooperating with the indexing elements of the guiding members to define rest positions of the actuating member between said steps of translational motion.

11. Dispenser according to claim 10, wherein the indexing elements of the guiding members consist of notches and the indexing elements of the actuating member consist of elastically deformable tabs.

12. Dispenser according to claim 10, further comprising abutment surfaces stationary relative to the support, for holding the actuating member in said rest positions when the driving member is being moved from its first position to its second position.

13. Dispenser according to claim 9, wherein said through hole(s) of said support communicate with at least one cavity into which the medication dose(s) fall after being expelled from the blister(s), and wherein said cavity(ies) communicate with the inside of a removable cap provided at an end of the dispenser.

14. Dispenser according to claim 9, further comprising a case in which said support, said blister(s), said actuating member and said converting means are provided.

15. Dispenser according to claim 14, wherein the blister(s) are not directly accessible to a user in any configuration of use of the dispenser.

16. Dispenser according to claim 14, wherein the case has side walls and top and bottom walls, and wherein the dispenser further comprises:
first locking means coupled to the case,
second locking means coupled to the driving member and engaging said first locking means for locking the driving member in its first position relative to the support,
first and second buttons respectively provided at the side walls, said first and second buttons being operable to disengage said first and second locking means for permitting the driving member to be moved relative to the support in the direction opposite to said determined direction from its first position to its second position,
third locking means for maintaining engagement between the first and second locking means, and
a third button operable to act on the third locking means to permit disengaging the first and second locking means by operating the first and second buttons.

17. Dispenser according to claim 16, wherein the first and second buttons are operable to act on the first locking means to disengage the first and second locking means.

18. Dispenser according to claim 17, wherein the third locking means are arranged to block the first locking means when an attempt is made to operate the first and second buttons while the third button is in a rest position.

19. Dispenser according to claim 18, wherein the first and second buttons are push buttons and the third button is a slide button.

20. Dispenser according to claim 19, wherein the third locking means are sides of a slidable part which carries the third button, said sides being arranged to block stop projections of the first locking means when an attempt is made to operate the first and second buttons while the third button is in a rest position, said sides comprising holes into which the stop projections enter when the third button is in an operated position and the first and second buttons are pressed.

21. Dispenser according to claim 20, wherein said sides of the slidable part further comprise stop projections which are blocked by the stop projections of the first locking means when the first and second buttons are pressed, to prevent the third button from moving from its rest position to its operated position.

22. Dispenser according to claim 16, wherein the third button is provided at the top wall of the case.

23. Dispenser according to claim 16, wherein the first and second buttons are arranged to disengage the first and second locking means only when operated simultaneously.

24. Dispenser according to claim 1, wherein the blisters are arranged as several separate blister packs.

25. Dispenser according to claim 1, wherein said medication contains drug for the treatment of cancer, drug having an immediate toxic effect or drug having an effect on the immune system.

26. Dispenser according to claim 25, wherein said medication comprises Cladribine or derivatives thereof.

27. Kit comprising a dispenser according to claim 1 and a description containing information on how to handle the dispenser and on the administration and dosing of the medication.

28. Method of operating a dispenser according to claim 13, comprising the following steps:
pulling the driving member from its first position to its second position relative to the support,
pushing the driving member from its second position to its first position relative to the support,
inclining the dispenser to make the expelled medication dose(s) fall into the cap by gravity, and
removing the cap to recover the expelled medication dose(s).

29. Method of operating a dispenser according to claim 13, comprising the following steps:
holding the case in a first hand,
operating the third button with a finger of the second hand,
operating the first and second buttons with two fingers of the first hand while maintaining the third button in its operated position,
pulling the driving member relative to the support with the second hand while maintaining the first and second buttons in their operated position to unlock the driving member,
continuing to pull the driving member until it reaches its second position relative to the support,
pushing the driving member from its second position to its first position relative to the support,
inclining the dispenser to make the expelled medication dose(s) fall into the cap by gravity, and
removing the cap to recover the expelled medication dose(s).

30. Dispenser according to claims 1, wherein said support comprises a rigid base support member and a compressible plate which is supported by the rigid base support member and which supports the blister(s), wherein said through hole(s) of said support each comprise a cutting member, wherein the actuating member comprises at least one pressing member, wherein the dispenser further comprises an array of cam surface(s) stationary relative to the support, and wherein the pressing member(s) of the actuating member are arranged to cooperate during each of said step(s) of translational motion of the actuating member with corresponding one(s) of said cam surface(s) before said pressure is exerted so as to move the corresponding blister(s) closer to the rigid base support member by compressing the compressible plate so that a sealant film of the corresponding blister(s) is pre-cut by the corresponding cutting member(s).

31. Dispenser according to claim 1, wherein said through hole(s) of said support communicate with at least one cavity into which the medication dose(s) fall after being expelled from the blister(s), and wherein said cavity(ies) communicate with the inside of a removable cap provided at an end of the dispenser.

32. Dispenser according to claim 1, further comprising a case in which said support, said blister(s), said actuating member and said converting means are provided.

33. Dispenser according to claim 16, wherein the first and second buttons are push buttons and the third button is a slide button.
